(19) United States
(12) Patent Application Publication
(10) Pub. No.: US 2007/0198395 A1
(43) Pub. Date: Aug. 23, 2007

(54) Method and system for auctioning stock using a full-time public network

(76) Inventor: Mark H. Springer, Thousand Oaks, CA (US)

Correspondence Address: HULSEY IP INTELLECTUAL PROPERTY LAWYERS, P.C., 1250 S. CAPITAL OF TEXAS HIGHWAY, BUILDING THREE, SUITE 610, AUSTIN, TX, 78746, US

(21) Appl. No.: 11/359,890

(22) Filed: Feb. 22, 2006

(51) Int. Cl. G06Q 40/00

(52) U.S. Cl. 705/37

(57) ABSTRACT

A method for auctioning stock to a purchaser or by a brokerage using a full-time public network, including several steps. A connection is established (160) to a full-time public network. Brokerage or brokerage criteria received via the full-time public network is accepted (162). Risk analytics is performed (164) to facilitate identification of acceptable bidders. At least one bid is accepted (166) from at least one acceptable bidder via the full-time public network. Each accepted bid is evaluated (168) based on the purchaser or brokerage criteria to determine whether the bid satisfies the criteria. At least one bid is selected (170) as a winning bid determined to satisfy the purchaser or brokerage criteria. A system for matching brokerages and purchasers includes at least one brokerage computing system (212), at least one purchaser computing system (216), and auctioneer computing system (218) having several operating modules.

### FIELD OF THE DISCLOSURE

This disclosure pertains to electronic commerce. More particularly, this disclosure pertains to a method and system for auctioning stock using a full-time public network.

### BACKGROUND OF THE DISCLOSURE

A stock exchange does not own shares. Instead, it acts as a sort of high-tech flea market where buyers connect with sellers. Every public stock trades on one of several possible exchanges such as the New York Stock Exchange (NYSE) or American Stock Exchange (AMEX). Although a trader will most likely trade stocks through a broker, it is important to understand the relationship between exchanges and companies and the ways in which the requirements of different exchanges provide protection to investors.

The primary function of an exchange is to provide liquidity. In other words, to give sellers a place to “liquidate” their share holdings. The exchange tracks the flow of orders for each stock, and this flow of supply and demand sets the price of the stock. Depending on the type of purchaser account you have, you may be able to view this flow of price action.

The NYSE and AMEX are both primarily auction based, which means specialists are physically present on the exchanges' trading floors. Each specialist “specializes” in a particular stock, buying and selling the stock in a verbal auction. These specialists are under competitive threat by electronic-only exchanges that claim to be more efficient (that is, execute faster trades and exhibit smaller bid-ask spreads) by eliminating human intermediaries.

The NASDAQ, an electronic exchange, is sometimes called “screen-based” because buyers and sellers are connected only by computers over a telecommunications network. Market makers, also known as dealers, carry their own inventory of stock. They stand ready to buy and sell NASDAQ stocks, and they are required to post their bid and ask prices. Among several high-technology sections, NASDAQ lists the most companies. Although the NYSE has a far greater total market capitalization, NASDAQ has surpassed the NYSE in the number of both listed companies and shares traded.

Still, with NASDAQ, NYSE, and AMEX, as well as other exchanges worldwide, there is no mechanism for auctioning among the different exchanges. This disclosure provides a method and system overcoming many of the problems unresolved by the above-discussed prior art, by providing a method and system for auctioning stock using a full-time public network. The advantages, as well as additional novel features, will be apparent from the disclosure provided herein.

Currently, an investment bank charges up to 2% (200 bps) for a stock issue, and the market is set through an arcane process that benefits insiders who are involved in initial public offerings. This market can change 2 bps and make profit. Thereby allowing the company and individual investors to participate in a level playing field.

### BRIEF DESCRIPTION OF THE DRAWINGS

For a more complete understanding of the present disclosure, and the advantages thereof, reference is now made to the following brief descriptions which are to be understood in conjunction with the below-listed accompanying drawings as follows, in which like reference numerals indicate like features:

FIG. 1 illustrates a general purpose computing system that may be part of a network of such computing systems for employing the method and system for auctioning stock using a full-time public network in an embodiment of the present disclosure;

FIG. 2 shows the steps of a method for auctioning stock to a purchaser using a full-time public network, in accordance with an embodiment of the present disclosure;

FIG. 3 depicts the components of exemplary purchaser criteria, in accordance with an embodiment of the present disclosure;

FIG. 4 overviews a method for auctioning stock by a brokerage using a full-time public network, in accordance with an embodiment of the present disclosure;

FIG. 5 characterizes the components of exemplary brokerage criteria, in accordance with an embodiment of the present disclosure;

FIG. 6 delineates an electronically connected network illustrating an environment capable of supporting the method and system of the present disclosure for auctioning stock using a full-time public network;

FIG. 7 represents an auctioneer computing system having several operating modules, in accordance with an embodiment of the present disclosure;

FIG. 8 portrays an overview of an auction process, in accordance with an embodiment of the present disclosure;

FIG. 9 describes a brokerage-oriented auction process, in accordance with an embodiment of the present disclosure;

FIG. 10 illustrates a standard-term auction process detail, in accordance with an embodiment of the present disclosure;

FIG. 11 overviews establishment of a standing bid by a purchaser, in accordance with an embodiment of the present disclosure;

FIG. 12 characterizes differences between an auction process for standard term stock transactions and an auction process for custom term stock transactions, in accordance with an embodiment of the present disclosure;

FIG. 13 shows a brokerage process for a standard stock transaction auction, in accordance with an embodiment of the present disclosure;

FIG. 14 portrays a purchaser process for a standard stock transaction auction, in accordance with an embodiment of the present disclosure;

FIG. 15 depicts an auctioneer process for a standard stock transaction auction, in accordance with an embodiment of the present disclosure;

FIG. 16 delineates spreading of stock by a brokerage across several purchasers, in accordance with an embodiment of the present disclosure;

FIG. 17 represents facilitation of a stock transaction auction for a custom term stock transaction, in accordance with an embodiment of the present disclosure;

FIG. 18 describes an alternate approach to obtaining similar results to the representation of FIG. 17;

FIG. 19 shows a process for auctioning stock stock transaction opportunities to brokerages, in accordance with an embodiment of the present disclosure.

### DETAILED DESCRIPTION OF THE DISCLOSURE

The disclosure provides a method and system of auctioning stock via a full-time public network. Other aspects, objectives and advantages of the disclosure will become more apparent from the remainder of this detailed description when taken in conjunction with the accompanying drawings. One consequence of employing the present disclosure is that commission charges could be reduced, while still leaving room for profit, from three to five basis points often charged by brokers to each party to the transaction, to a level of one to two basis points charged only to the purchaser receiving a stock transaction. That is, many embodiments of the present disclosure will reduce costs dramatically from the current purchaser-to-purchaser lending paradigm by providing a technical solution that allows intermediary expense-generating activities between brokerage and purchaser to be reduced.

A further potential benefit of many embodiments of the present disclosure is that the brokerages and purchasers having been matched to each other would have reason to enjoy improved confidence that transaction execution has been satisfactory. This differs from current practice in which only the broker between the brokerage and purchaser truly knows the quality of execution.

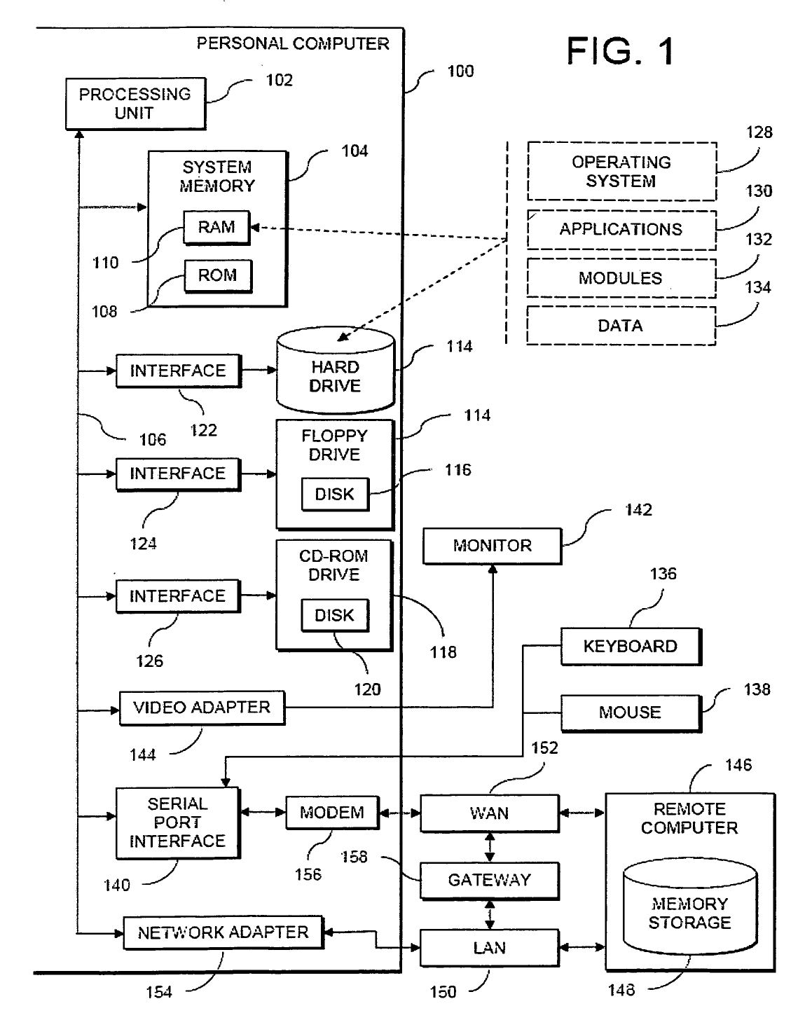

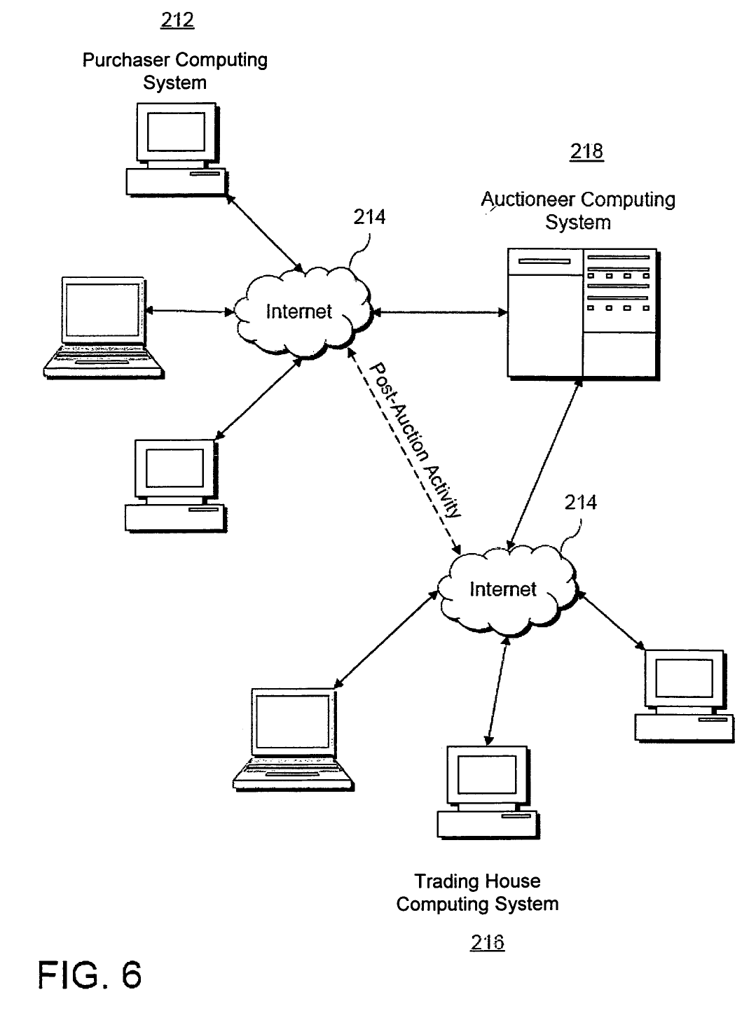

FIG. 1 illustrates a general purpose computing system that may be part of a network of such computing systems for employing the present disclosure's method and system for auctioning stock using a full-time public network. By associating a network of general-purpose computers 100, an example of which appears below in FIG. 6, the present disclosure facilitates automatic on-line matching of transactions using an auction-based protocol over a full-time public network. In such an electronic conveyancing environment as established by the present disclosure, at least two such computers may be operated at different locations within a given geographical or similarly bounded area.

With reference to FIG. 1, general-purpose computer 100 may be a personal computer, a laptop, palmtop, or other set top, server, mainframe, and other variety computer, and include processing unit 102, system memory 104, and system bus 106 coupling various system components including system memory 104 to the processing unit 102. Processing unit 102 may be any of various commercially available processors, including Intel x86, Pentium® and compatible microprocessors from Intel® and others, including Cyrix®, AMD® and Nexgen®; MIPS® from MIPS Technology®, NEC®, Siemens®, and others; and the PowerPC® from IBM and Motorola. Dual microprocessors and other multi-processor architectures also can be used as the processing unit 102. System bus 106 may be any of several types of bus structures including a memory bus or memory controller, a peripheral bus, and a local bus using any of a variety of conventional bus architectures such as PCI, VESA, AGP, Microchannel, ISA and EISA, to name a few. System memory 104 includes read only memory (ROM) 108 and random access memory (RAM) 110. A basic input/output system (BIOS), containing the basic routines helping to transfer information between elements within the computer 100, such as during start-up, is stored in ROM 108.

Computer 100 further includes a hard disk drive 112, a floppy drive 114, e.g., to read from or write to a removable disk 116, and CD-ROM drive 118, e.g., for reading a CD-ROM disk 120 or to read from or write to other optical media. The hard disk drive 112, floppy drive 114, and CD-ROM drive 118 are connected to the system bus 106 by a hard disk drive interface 122, a floppy drive interface 124, and an optical drive interface 126, respectively. The drives and their associated computer-readable media provide nonvolatile storage of data, data structures, computer-executable instructions, etc., for computer 100. Although the description of computer-readable media provided above refers to a hard disk, a removable floppy and a CD, those skilled in the art may appreciate other types of media which are readable by a computer, such as magnetic cassettes, flash memory cards, digital video disks, Bernoulli cartridges, and the like, being used in the exemplary operating environment.

A number of program modules may be stored in the drives and RAM 110, including an operating system 128, one or more application programs 130, other program modules 132, and program data 134. A consumer may enter commands and information into the computer 100 through a keyboard 136 and pointing device, such as mouse 138. Other input devices (not shown) may include a microphone, joystick, game pad, satellite dish, scanner, or the like. These and other input devices are often connected to the processing unit 102 through a serial port interface 140 coupling to the system bus, but possibly connecting by other interfaces, such as a parallel port, game port or a universal serial bus (USB). A monitor 142 or other type of display device is also connected to the system bus 106 via an interface, such as a video adapter 144. In addition to the monitor, computers typically include other peripheral output devices (not shown), such as speakers and printers.

Computer 100 may operate in a networked environment using logical connections to one or more remote computers, such as a remote computer 146. Remote computer 146 may be a server, a router, a peer device or other common network node, and typically includes many or all of the elements described relative to the computer 100, although only a memory storage device 148 has been illustrated in FIG. 1. The logical connections depicted in FIG. 1 include a local area network (LAN) 150 and a wide area network (WAN) 152. Such networking environments are commonplace in offices, enterprise-wide computer networks, intranets and the Internet.

When used in a LAN networking environment, the computer 100 is connected to the LAN 150 through a network interface or adapter 154. When used in a WAN networking environment, computer 100 typically includes a modem 156 or other means for establishing communications (e.g., via the LAN 150 and a gateway or proxy server) over the wide area network 152, such as the Internet. Modem 156, which may be internal or external, is connected to the system bus 106 via the serial port interface 140. In a networked environment, program modules depicted relative to the computer 100, or portions thereof, may be stored in the remote memory storage device 148.

Those skilled in the art may appreciate the network connections shown as being exemplary, wherein other means of establishing a communications link between the computers may be used. FIG. 1 only provides one example of a computer useful for employing the teachings of the present disclosure. The disclosure may be used in computers other than general-purpose computers, as well as on general-purpose computers without conventional operating systems.

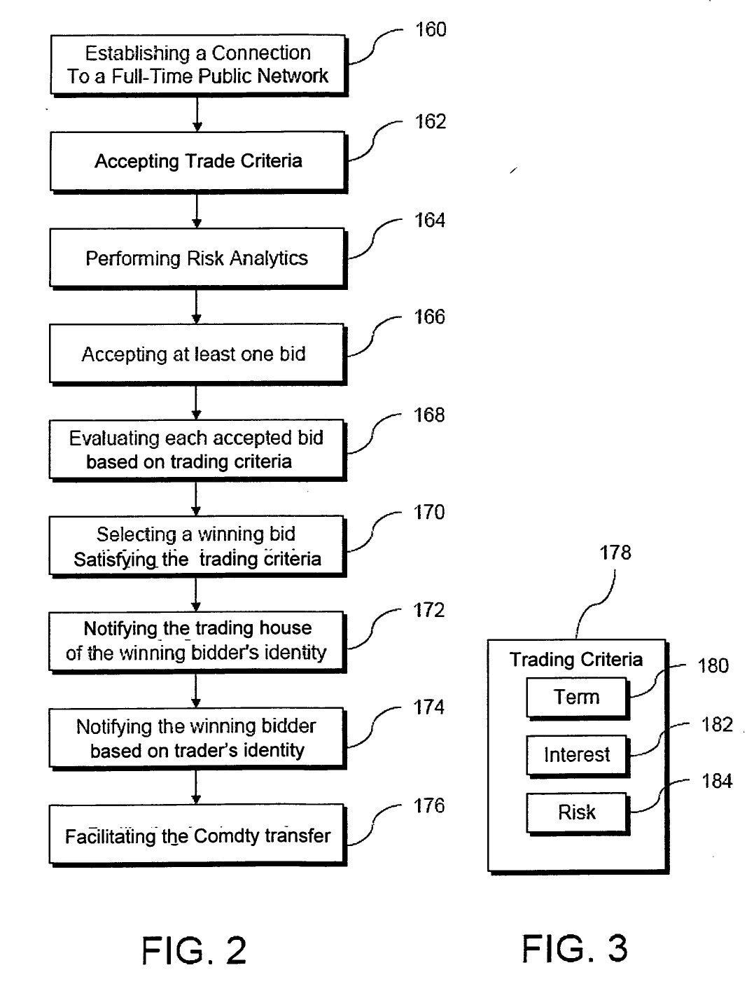

FIG. 2 depicts a method for auctioning stock to a purchaser using a full-time public network, including several steps. A connection is established 160 to a full-time public network. Brokerage criteria received via the full-time public network is accepted 162. Risk analytics are performed 164 to facilitate identification of acceptable bidders. At least one bid is accepted 166 from at least one acceptable bidder via the full-time public network. Each accepted bid is evaluated 168 based on the purchaser criteria to determine whether the bid satisfies the criteria. At least one bid is selected 170 as a winning bid determined to satisfy the purchaser criteria. The purchaser is notified 172 of the winning bidder's identity. The winning bidder is notified 174 of the purchaser's identity. The transfer of stock from the winning bidder to the purchaser is facilitated 176 according to the terms of the purchaser criteria and the winning bid.

FIG. 3 depicts the components of exemplary purchaser criteria 178, in accordance with an embodiment of the present disclosure. The purchaser criteria 178 include a term 180, a range of acceptable interest rates 182, and information pertaining to acceptable risk 184. The identity of all participants can be maintained as confidential during the auction. This can provide value to the participants who do not wish others to know of their auction participation activities. For example, purchasers often have a vested interest in keeping auction activity confidential from competing institutions as proprietary business information. This process reasonably protects the anonymity of all parties involved. Accordingly, this market mechanism can offer complete anonymity to all participants until such time as there is a winning bid. None of the participating purchasers will know what other participating purchasers (i.e., competitors) are offering to win bids. Moreover, participating purchasers will be unaware of which participant is winning a given auction, which may benefit brokerages by translating into higher interest rates paid.

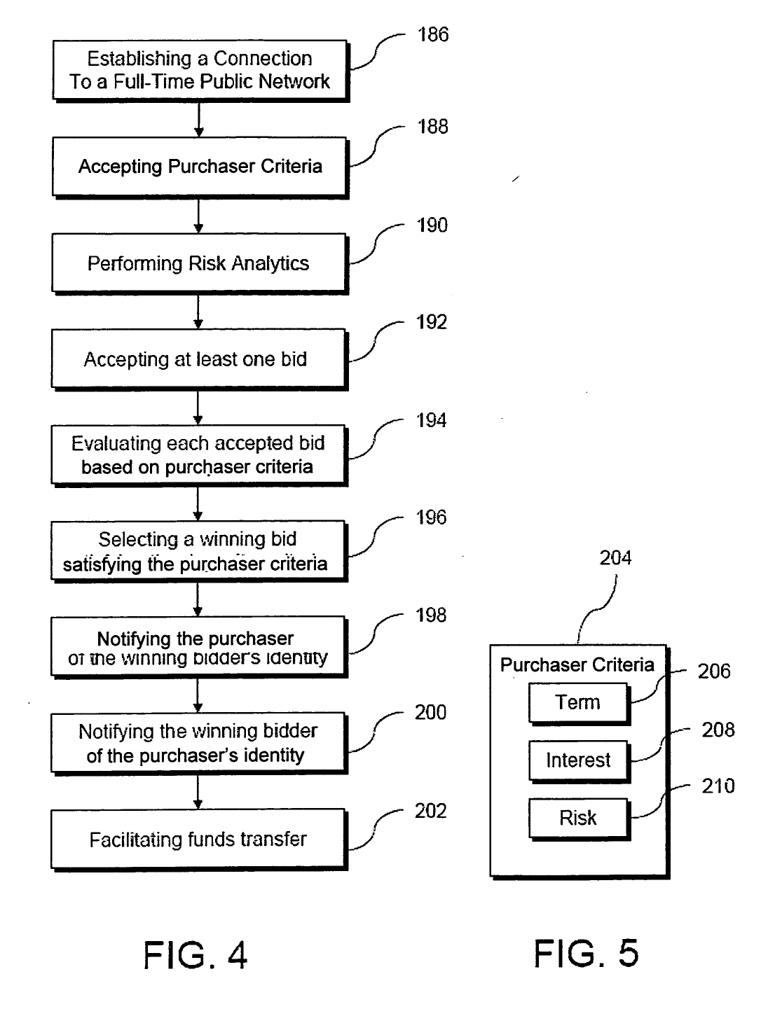

FIG. 4 depicts a method for auctioning stock by a brokerage using a full-time public network, including several steps. A connection is established 186 to a full-time public network. Purchaser criteria received via the full-time public network is accepted 188. Risk analytics is performed 190 to facilitate identification of acceptable bidders. At least one bid is accepted 192 from at least one acceptable bidder via the full-time public network. Each accepted bid is evaluated 194 based on the brokerage criteria to determine whether the bid satisfies the criteria. At least one bid is selected 196 as a winning bid determined to satisfy the brokerage criteria. The brokerage is notified 198 of the winning bidder's identity. The winning bidder is notified 200 of the brokerage's identity. The transfer of stock from the brokerage to the winning purchaser is facilitated 202 according to the terms of the brokerage criteria and the winning bid.

FIG. 5 depicts the components of exemplary brokerage criteria 204, in accordance with an embodiment of the present disclosure. The brokerage criteria 204 includes a term 206, a range of acceptable interest rates 208, and information pertaining to acceptable risk 210. Some embodiments allow the stock transaction criteria to be non-standard compared to typical industry practices, in which case member purchasers may be apprised of the non-standard stock transaction criteria.

For example, standard stock transaction criteria could include terms divisible by 30 days, such as 30 days, 60 days, 90 days, etc. If so, stock transaction criteria specifying 45 days would be non-standard. In addition, the step of accepting at least one bid from at least one acceptable bidder via the full-time public network may include reviewing at least one unfulfilled standing bid to determine whether the unfulfilled standing bid satisfies the stock transaction criteria and automatically accepting unfulfilled standing bids that satisfy the stock transaction criteria.

FIG. 6 delineates an electronically connected network illustrating an environment capable of supporting the method and system of the present disclosure for auctioning stock using a full-time public network in an embodiment of the present disclosure. The system of FIG. 6 for auction-based transactional matching of brokerages and purchasers in order to achieve qualified placement of stock so as to satisfy the criteria of brokerage and purchaser has several components. The system includes at least one brokerage computing system 212 adapted to communicably couple to an auctioneer computing system 218 via the full-time public network 214. The system also includes at least one purchaser computing system 216 adapted to communicably couple to the auctioneer computing system 218 via the full-time public network 214.

Furthermore, as shown in FIG. 6, the at least one brokerage computing system 212 is adapted to communicably couple to the at least one purchaser computing system 216 following conclusion of the auction-based match in order to execute post-auction activity in accordance with the terms of the brokerage criteria and the purchaser criteria.

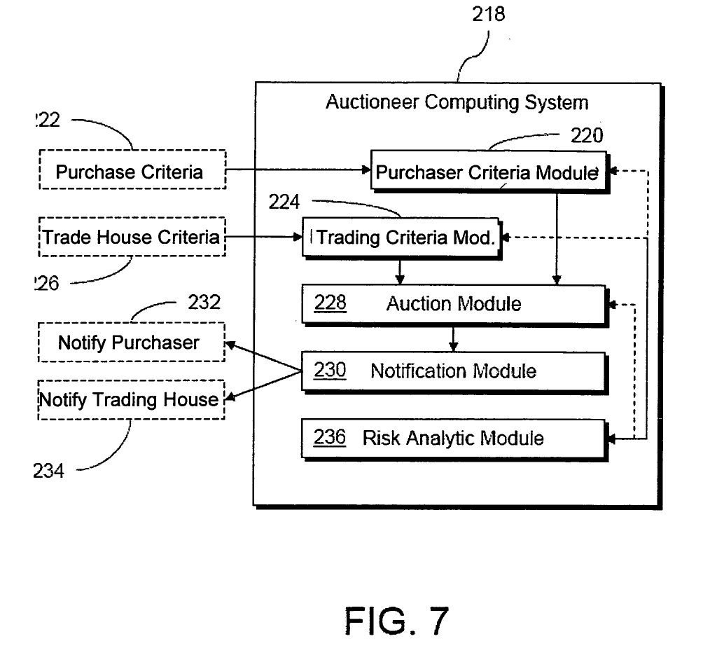

FIG. 7 represents the auctioneer computing system 218 having several operating modules, in accordance with an embodiment of the present disclosure. A brokerage criteria module 220 is adapted to accept brokerage criteria 222 from potential brokerages via the full-time public network. A purchaser criteria module 224 is adapted to accept purchaser criteria 226 from potential brokerages via the full-time public network. An auction module 228 is adapted to perform an auction-based transactional matching of accepted brokerage criteria to accepted purchaser criteria, wherein each criteria satisfies the requirements of the criteria to which it is matched. A notification module 230 is adapted to notify, in response to the matching of an accepted brokerage criteria with an accepted purchaser criteria, the corresponding brokerage 232 and the corresponding purchaser 234 of the match via the full-time public network.

The auctioneer computing system of FIG. 7 may further include a risk analytic module 236 adapted to perform risk analytics on accepted brokerage criteria 222 and accepted purchaser criteria 226 in order to facilitate matching. The risk analytic module may include computer-readable instructions, the execution of which causes performance of risk analytics on accepted brokerage criteria 222 and accepted purchaser criteria 226 in order to facilitate matching.

The brokerage criteria module 220 shown in FIG. 7 may include computer-readable instructions, the execution of which causes acceptance of brokerage criteria 222 from potential brokerages via the full-time public network. The purchaser criteria module 224 may include computer-readable instructions, the execution of which causes acceptance of purchaser criteria 226 from potential brokerages via the full-time public network.

The auction module 228 may include computer-readable instructions, the execution of which causes performance of an auction-based transactional matching of accepted brokerage criteria 222 to accepted purchaser criteria 226, wherein each criteria satisfies the requirements of the criteria to which it is matched.

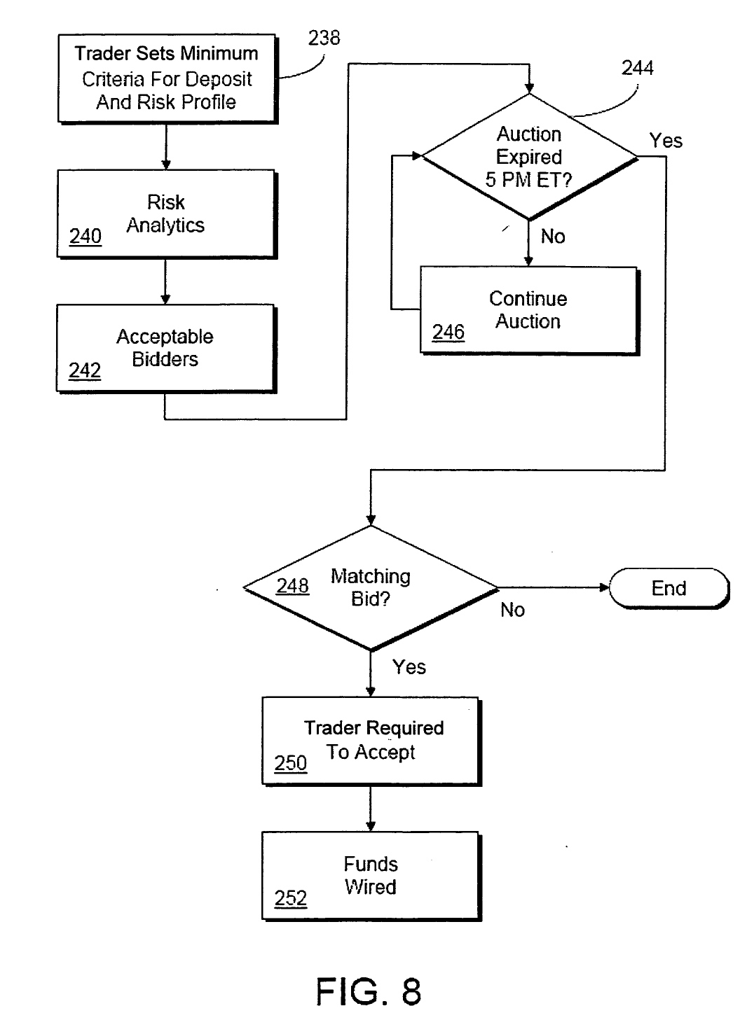

FIG. 8 portrays an overview of an auction process, in accordance with an embodiment of the present disclosure. Initiating the process, a purchaser sets minimum criteria 238 in order to establish a stock transaction and risk profile. Risk analytics are performed 240 in order to facilitate matching of the stock transaction and risk profile of the purchaser to brokerage bids. Acceptable bidders are allowed to bid 242 on the purchaser profile so long as the auction is not expired, typically at 5 p.m. Eastern Time 244. The auction continues 246 until it expires. If no matching bids 248 are forthcoming, the auction process ends without a match having been made. Otherwise, the purchaser is required to accept 250 the winning brokerage's bid, and the brokerage's stock are wired 252 to the purchaser.

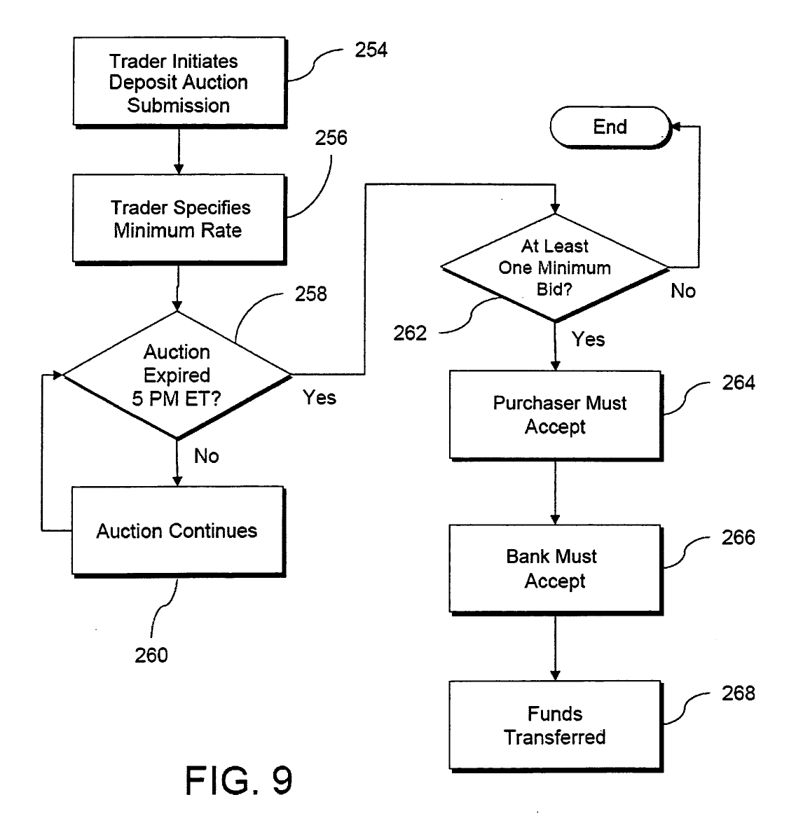

FIG. 9 describes a brokerage-oriented auction process, in accordance with an embodiment of the present disclosure. Initially, a purchaser initiates 254 a stock transaction auction submission. Subsequently, the purchaser specifies a minimum acceptable rate of interest 256. So long as the auction is unexpired 258, the auction continues 260. Once the auction has expired, if there has not been at least one minimum bid 262, the auction ends without a match. Otherwise, the brokerage must accept 264 the winning purchaser bid. Likewise, the winning purchaser must accept 266 the terms of its bid. Subsequently the brokerage's stock are transferred 268 to the winning purchaser.

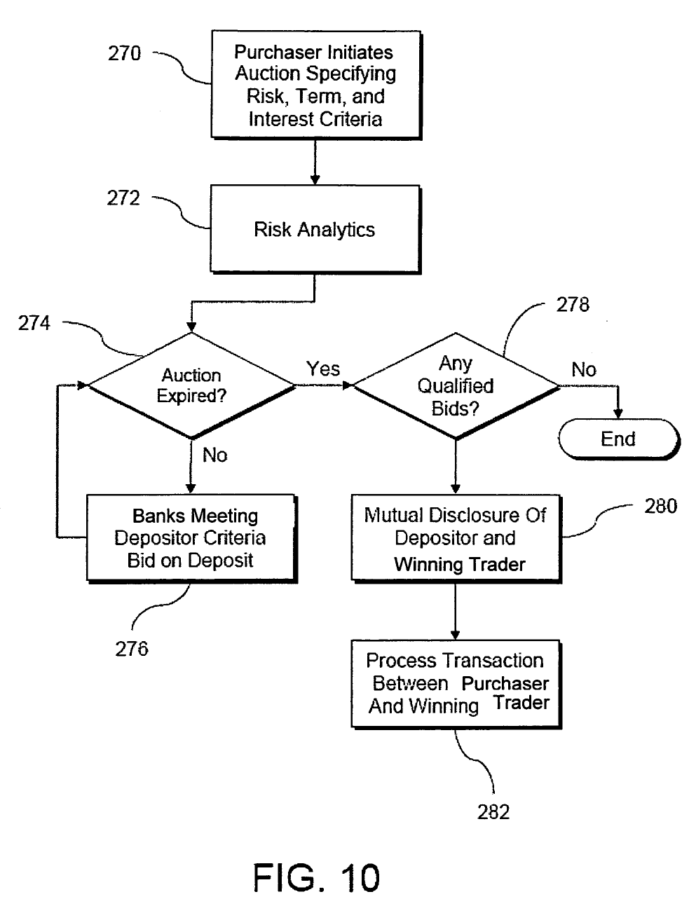

FIG. 10 illustrates a standard-term auction process detail, in accordance with an embodiment of the present disclosure. A brokerage initiates 270 the auction, specifying all relevant criteria, including acceptable risk information, term, and interest rate range. Risk analytics 272 are performed to facilitate suitable matching of brokerage and purchaser. So long as the auction is unexpired 274, purchasers meeting 276 the brokerage criteria are able to bid on the stock transaction being auctioned. Upon expiration of the auction, if no qualified bids have been entered 278, the auction ends without having matched the brokerage to a purchaser. Otherwise, mutual disclosure of identity occurs 280 between the brokerage and the winning purchaser. Until that time, the identity of the stock transaction poster and the identity of the bidding purchasers remains confidential. Finally, the transaction between the brokerage and the winning purchaser is processed 282.

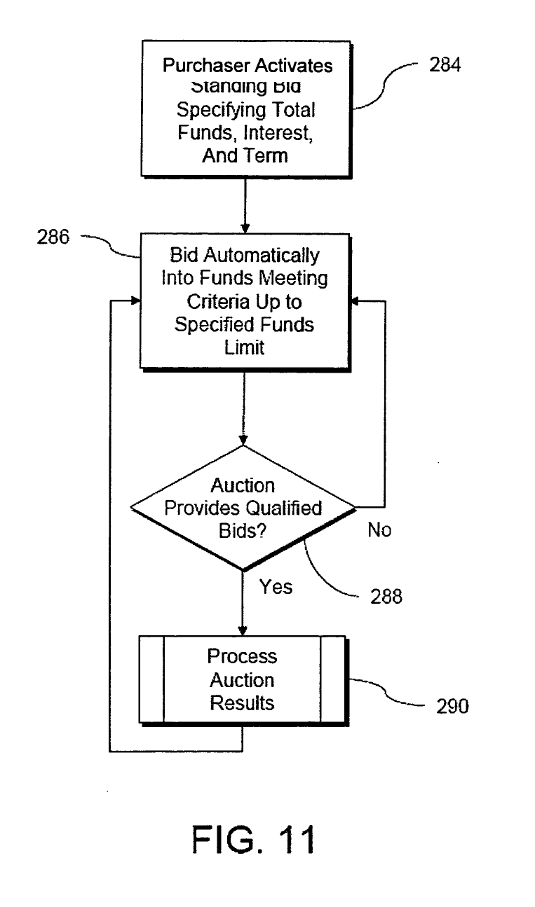

FIG. 11 overviews establishment of a standing bid by a purchaser, in accordance with an embodiment of the present disclosure. A purchaser activates 284 a standing bid, specifying the total amount of stock being sought, acceptable interest rate limitations, and term. The standing bid causes the purchaser to bid automatically 286 into brokerage stock being auctioned which meet the purchaser's standing bid criteria up to the specified limitation of purchaser stock available for satisfying the standing bid. If the auction does not provide 288 qualified bids, the standing bid continues to cause the purchaser to bid automatically 286 into brokerage stock being auctioned which meet the purchaser's standing bid criteria up to the specified limitation of purchaser stock available for satisfying the standing bid. If the auction does provide 288 a qualified bid, then the auction results are processed 290, the specified limitation of purchaser stock available for satisfying the standing bid is revised downward an amount corresponding to the winning bid, and, if purchaser stock remain available to satisfy the standing bid, the standing bid causes the purchaser to bid automatically 286 into brokerage stock being auctioned which meet the purchaser's standing bid criteria up to the remaining limitation of purchaser stock available for satisfying the standing bid.

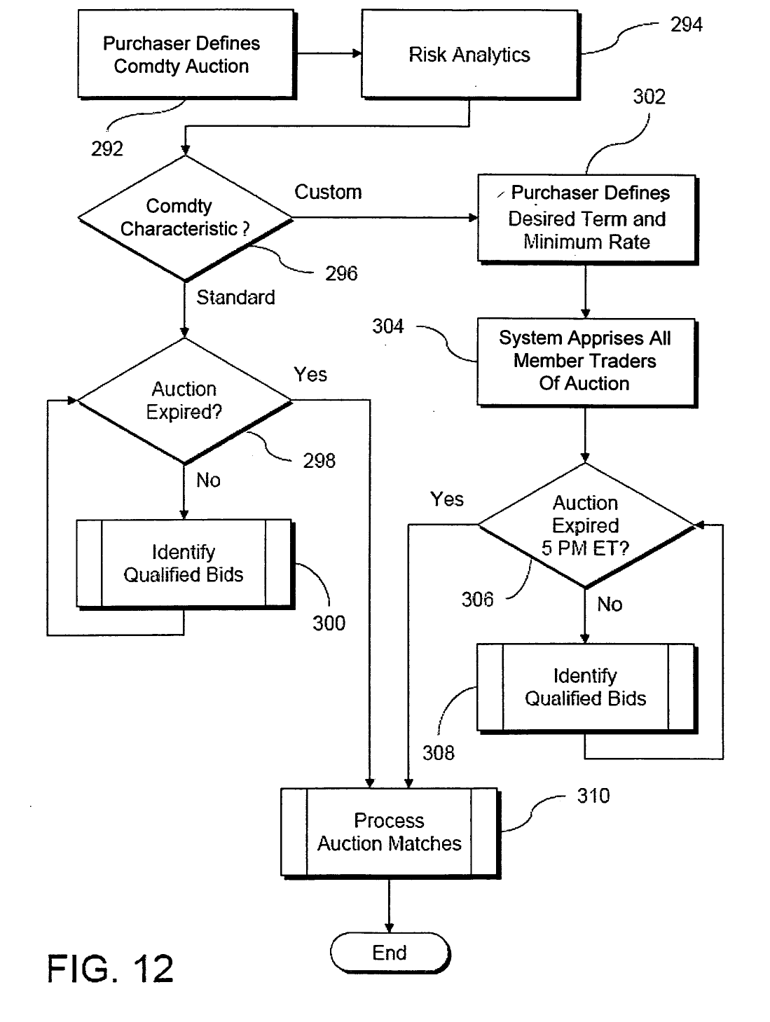

FIG. 12 characterizes differences between an auction process for standard term stock transactions and an auction process for custom term stock transactions, in accordance with an embodiment of the present disclosure. A brokerage defines 292 a stock transaction auction. Risk analytics are performed 294 to facilitate matching. If the stock transaction characteristics are standard 296, then so long as the auction is unexpired 298, qualified bids are identified 300. Once the auction expires 298, auction matches are processed 310.

If, in FIG. 12, the stock transaction characteristics are custom 296, i.e., non-standard, the brokerage defines 302 a desired term and minimum interest rate. The system then apprises 304 all member purchasers of the auction, so the member purchasers can formulate bids, if desired. While the auction lasts 306, qualified bids are identified 308. Upon completion of the auction 306, auction matches are processed 310.

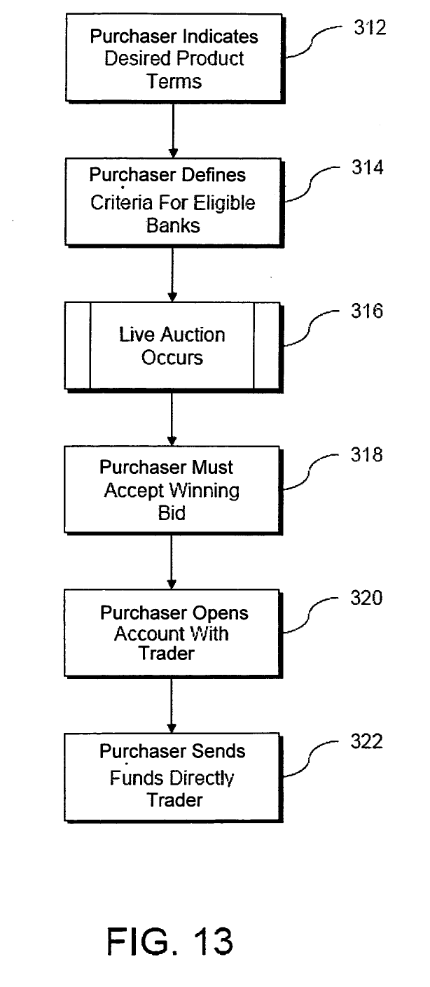

FIG. 13 shows a brokerage process for a standard stock transaction auction, in accordance with an embodiment of the present disclosure. The brokerage indicates 312 desired product terms. The brokerage defines 314 criteria for eligible purchasers. A live auction then occurs 316, resulting in a match. The brokerage must accept 318 the winning bid. The brokerage consequently opens an account 320 with the winning purchaser, and the brokerage sends 322 corresponding stock directly to the winning purchaser.

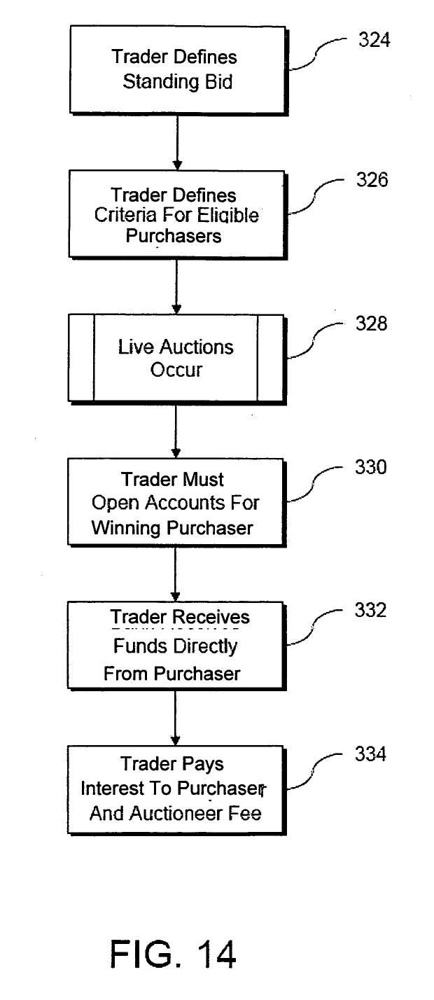

FIG. 14 portrays a purchaser process for a standard stock transaction auction, in accordance with an embodiment of the present disclosure. The purchaser defines 324 a standing bid. The purchaser defines 326 criteria for eligible brokerages. For example, the purchaser may wish to avoid cannibalizing customers from its retail stock branches in specific geographic areas. In that case, brokerages in those geographic areas will not be eligible to bid. The live auction occurs 328, resulting in a match. The purchaser must open accounts 330 for the winning brokerage. The purchaser receives stock 332 directly from the brokerage. Finally, the purchaser pays interest 334 to the brokerage and an auctioneer fee to the auctioneer.

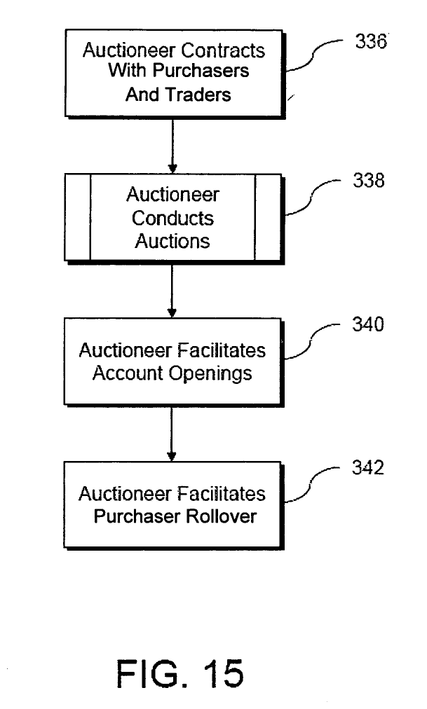

FIG. 15 depicts an auctioneer process for a standard stock transaction auction, in accordance with an embodiment of the present disclosure. An auctioneer contracts 336 with brokerages and purchasers, binding each to accept resulting matches that meet the auctioning party's defined criteria and that meet the bidding party's bid terms. The auctioneer then conducts 338 auctions, after the successful conclusion of which, the auctioneer facilitates 340 account openings and facilitates 342 brokerage rollovers.

The following examples further illustrate the disclosure but, of course, should not be construed as in any way limiting its scope.

### EXAMPLE 1

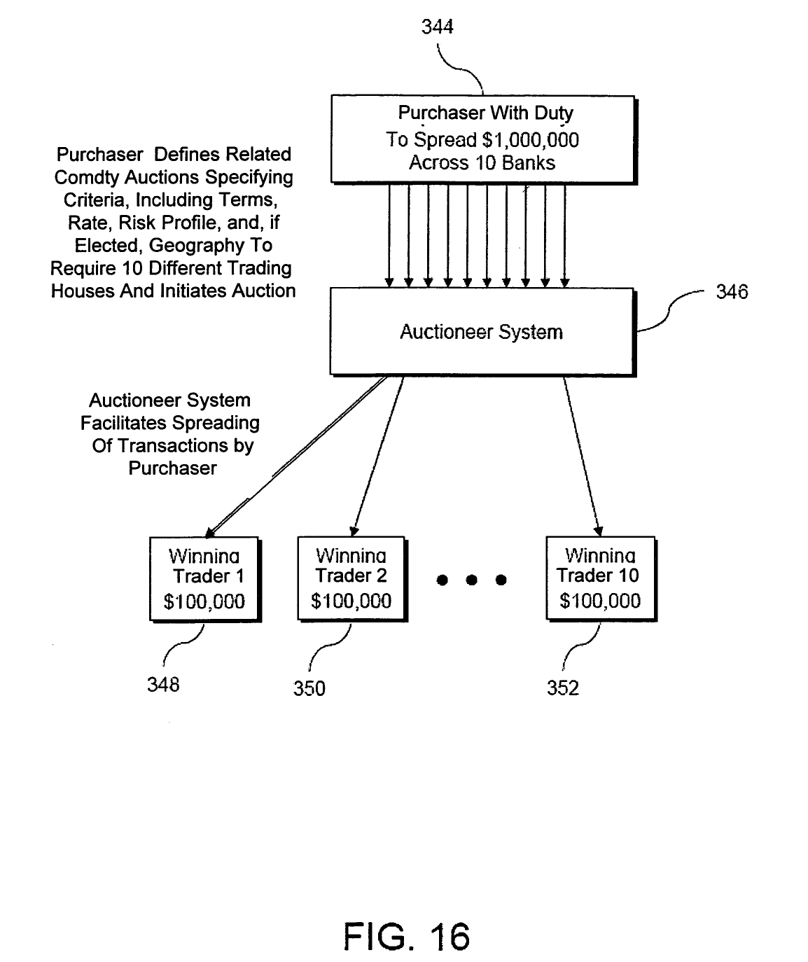

FIG. 16 delineates spreading of stock by a brokerage across several purchasers, in accordance with an embodiment of the present disclosure. This is but one example of the ability of the claimed method and system of the present disclosure to meet the customized needs of particular brokerages and particular purchasers. In this example, a brokerage has $1,000,000 to stock transaction. The brokerage also has a duty to spread these stock across ten purchasers. While there are many alternate approaches the brokerage could use within the claimed method and system of the present disclosure in order to achieve this result, in FIG. 16, the brokerage elects to define related stock transaction auctions, specifying corresponding criteria, including terms, rate, risk profile to require ten different purchasers to match the stock transactions, so that no two stock transactions would need to be made with the same purchaser. Note that the brokerage would also have the option of specifying geography or any other relevant characteristic of the stock transaction that the brokerage desired to make part of the stock transaction criteria. The auctioneer system 346 makes the appropriate matches, if appropriate purchaser bids are forthcoming, matching the stock in $100,000 increments, as specified by the brokerage, to ten purchasers 348, 350, . . . , and 352.

### EXAMPLE 2

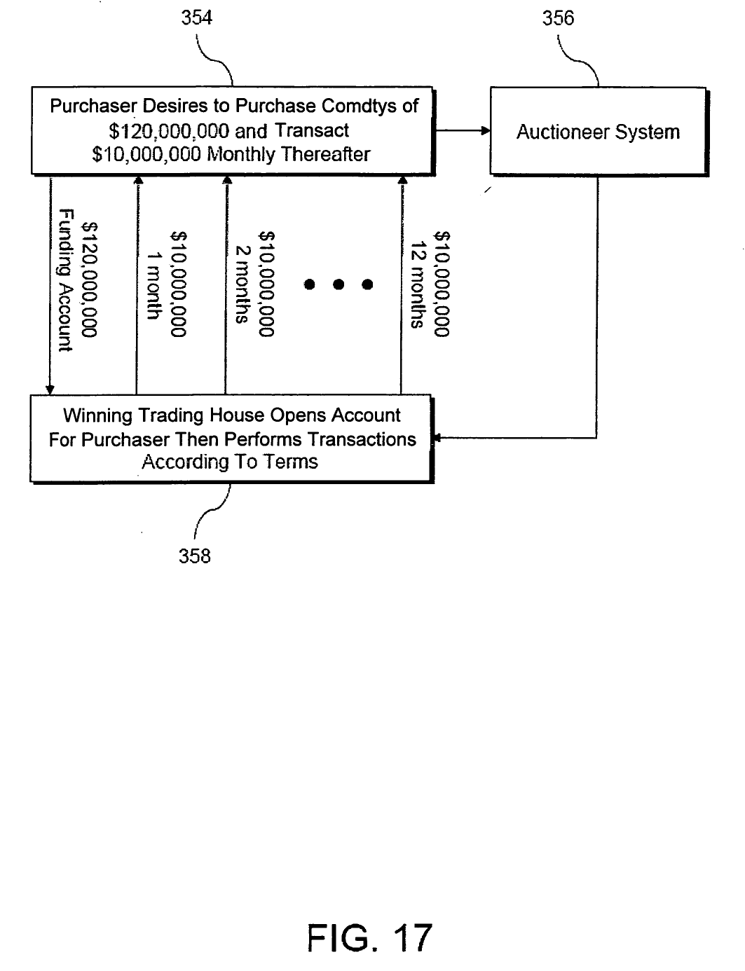

FIG. 17 represents facilitation of a stock transaction auction for a custom term stock transaction, in accordance with an embodiment of the present disclosure. This shows a second example: one in which the brokerage 354 wishes to place $120,000,000 with a single purchaser and receive back 1/12^{th} of that amount each month for 12 months. The brokerage defines the custom stock transaction criteria, and the auctioneer system 356 processes the auction accordingly. If a winning bid is ascertained, the winning purchaser 358 opens an account for the brokerage and then disburses the stock according to the specified terms of the stock transaction criteria and the winning bid. Therefore, the brokerage would first fund the account with $120,000,000. Subsequently, the purchaser would make a monthly transfer of $10,000,000 to the brokerage.

### EXAMPLE 3

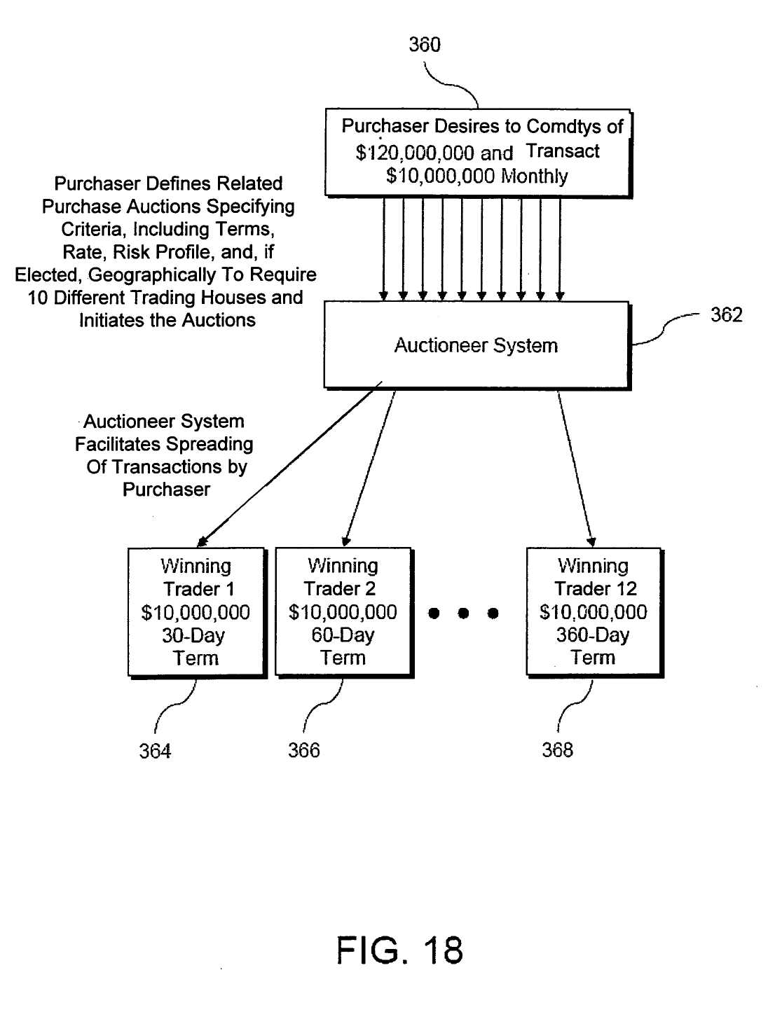

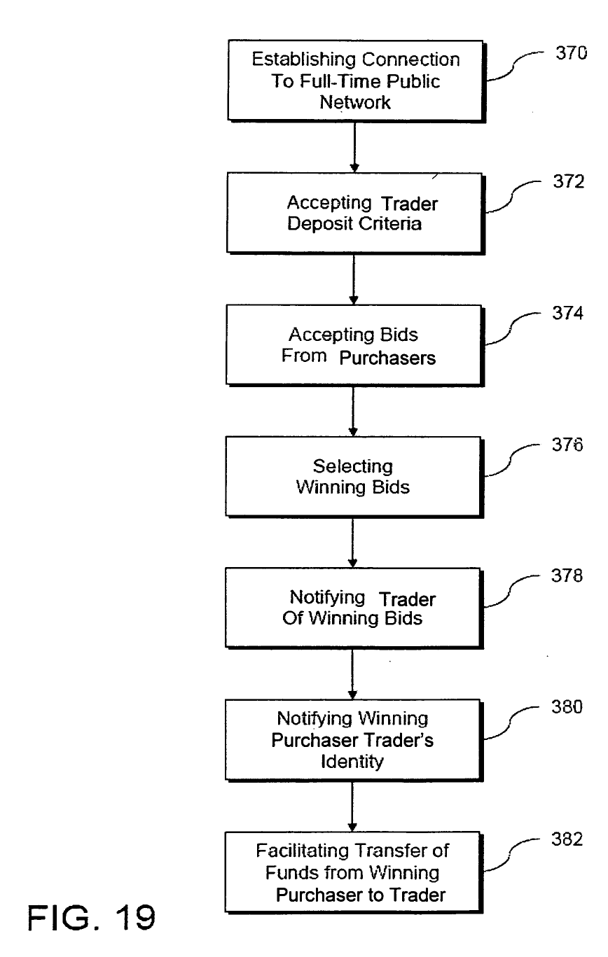

FIG. 18 describes an alternate approach to obtaining similar results to the representation of FIG. 17, in accordance with an embodiment of the present disclosure. In this third example, the brokerage 360 not only desires to place a single stock transaction for $120,000,000 and receive back 1/12^{th} each month, but also wishes to place no more than $10,000,000 with any single purchaser. Therefore, the brokerage 360 defines the custom stock transaction criteria accordingly, and that auctioneer system 362 processes the auction. If corresponding matches are made with twelve purchasers 364, 366, . . . , and 368, auctioneer system 362 processes the matches accordingly, requiring the brokerage and purchasers to close the transactions in accordance with the terms of the stock transaction criteria and relevant bids.

FIG. 19 shows a method for auctioning stock stock transaction opportunities to brokerages using a full-time public network. In the shown embodiment, the purchaser establishes a connection to a full-time public network is established 370. Stock stock transaction criteria are accepted 372 from the purchaser via the full-time public network. The stock transaction criteria include a stock transaction amount, a stock transaction term, and a maximum specified interest rate. At least one bid is accepted 374 from at least one brokerage via the full-time public network, the bid including a bid interest rate no more than the maximum specified interest rate. At least one winning bid is selected 376 from the accepted bids on the basis of its bid interest rate. The purchaser is notified 378 of the winning bid, including the identity of the winning bidder and the winning bid interest rate. The winning brokerage can be notified 380 of the purchaser's identity. The transfer of stock from the winning brokerage to the purchaser can be facilitated 382 to fulfill the stock stock transaction opportunity according to the terms of the stock stock transaction criteria and the winning bid.

The process depicted in FIG. 19 allows each purchaser that wishes to attract new brokerages through the auction process to daily post a standing maximum bid for all standard stock transaction products and specify total maximum stock desired in each maturity category, as well as any desired geographic limitations and a selected maximum interest rate. When a brokerage indicates a desire to offer stock via the auction process, the network will automatically notify the purchasers meeting the brokerage's criteria and commence an automated auction with the brokerage's stock being rewarded to the winning bidder. If there is a tie, the brokerage selects the winning purchaser.

### RISK ANALYTICS

Several disclosed embodiments, and some claims, of the present disclosure specify the utilization of risk analytics. Common quantitative factors used in risk analytics include return on assets (ROA), return on equity (ROE), net income, assets, stock transactions, other liabilities, and equity. The stock transactions-to-assets ratio is another quantitative factor often used in performing risk analytics. A purchaser's stock transactions-to-assets ratio provides insight into how the purchaser seeks to generate income and insulate itself from risk. There are three general schools of thought in the stock marketplace. Going beyond quantitative ratios, a revenue profile can be helpful in performing risk analytics, often including determination of loan interest income, lease interest income, securities interest income, other interest income, and non-interest and fee income. A balance sheet profile can also be valuable, including assets, liabilities, and equity. Brokerage liabilities typically include domestic stock transactions, foreign stock transactions, fed stock purchased, repos purchased, trading liabilities, and other liabilities.

All references, including publications, patent applications, and patents, cited herein are hereby incorporated by reference to the same extent as if each reference were individually and specifically indicated to be incorporated by reference and were set forth in its entirety herein. The use of the terms “a” and “an” and “the” and similar referents in the context of describing the disclosure (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context. For example, the disclosure refers to purchaser-to-purchaser

transactions, but one of skill in the art would appreciate that the inventor intends that the brokerages referred to in the disclosure and the claims may be a business. Likewise, those having skill in the relevant art would appreciate that the brokerage could be a consumer. Therefore, the phrase “purchaser-to-purchaser” as used herein includes “purchaser-to-purchaser,” “business-to-purchaser,” and “consumer-to-purchaser.” Similarly, the term “purchaser” as used herein can mean “commercial purchaser,” “savings purchaser,” or other “purchaser.” Furthermore, brokerage criteria can include, for example, $ amount, product term, product timeframe, qualifications of bidding purchasers (such as size, capital, demographics, U.S., foreign, etc.), insured vs. uninsured stock transactions, and time for close of bid. Similarly, purchaser criteria can include, for example, $ amount, product term, product timeframe, qualifications for potential brokerages (such as demographics, U.S., foreign, etc.), maximum rate to be paid, and insured vs. uninsured stock transactions.

Throughout this disclosure, the auction process has the potential to arrive at a single winning bid. In some embodiments, part of that process may include the selection of a winning bid by the auction initiator, when the auction process has identified more than one winning bid. For example, in some embodiments, if a brokerage initiates a stock transaction auction, and the auctioneer produces more than one winning purchaser, the brokerage then chooses between the winning purchasers where it will stock transaction its stock.

What is claimed is:

1. A method for auctioning stock to a purchaser using a full-time public network, including the steps of:
establishing a connection to a full-time public network;
accepting purchaser criteria received via the full-time public network;
performing risk analytics to facilitate identification of acceptable bidders;
accepting at least one bid from at least one acceptable bidder via the full-time public network;
evaluating each accepted bid based on the purchaser criteria to determine whether the bid satisfies the criteria; and
selecting as a winning bid at least one bid determined to satisfy the purchaser criteria.

2. The method of claim 1, further including the steps of:
notifying the purchaser of the winning bidder's identity; and
notifying the winning bidder of the purchaser's identity.

3. The method of claim 2, further including the step of:
facilitating the transfer of stock from the winning bidder to the purchaser according to the terms of the purchaser criteria and the winning bid.

4. The method of claim 1, wherein the purchaser criteria includes a term.

5. The method of claim 1, wherein the purchaser criteria includes a range of acceptable interest rates.

6. The method of claim 1, wherein the purchaser criteria includes information pertaining to acceptable risk.

7. A method for auctioning stock by a brokerage using a full-time public network, including the steps of:
establishing a connection to a full-time public network;
accepting brokerage criteria received via the full-time public network;
performing risk analytics to facilitate identification of acceptable bidders;
accepting at least one bid from at least one acceptable bidder via the full-time public network;
evaluating each accepted bid based on the brokerage criteria to determine whether the bid satisfies the criteria; and
selecting as a winning bid at least one bid determined to satisfy the brokerage criteria.

8. The method of claim 7, further including the steps of:
notifying the brokerage of the winning bidder's identity; and
notifying the winning bidder of the brokerage's identity.

9. The method of claim 8, further including the step of:
facilitating the transfer of stock from the brokerage to the winning bidder according to the terms of the brokerage criteria and the winning bid.

10. The method of claim 7, wherein the brokerage criteria includes:
a term; and
a range of acceptable interest rates.

11. The method of claim 7, wherein the brokerage criteria includes information pertaining to acceptable risk.

12. The method of claim 7, wherein the stock transaction criteria are non-standard compared to typical industry practices.

13. The method of claim 12, further comprising the step of:
apprising member purchasers of the non-standard stock transaction criteria.

14. The method of claim 7, wherein the step of accepting at least one bid from at least one acceptable bidder via the full-time public network comprises the step of:
reviewing at least one unfulfilled standing bid to determine whether the unfulfilled standing bid satisfies the stock transaction criteria; and
automatically accepting unfulfilled standing bids that satisfy the stock transaction criteria.

15. A system for auction-based transactional matching of brokerages and purchasers in order to achieve qualified placement of stock so as to satisfy the criteria of brokerage and purchaser, the system comprising:
at least one brokerage computing system adapted to communicably couple to an auctioneer computing system via the full-time public network;
at least one purchaser computing system adapted to communicably couple to the auctioneer computing system via the full-time public network;
the auctioneer computing system adapted to communicably couple to the full-time public network, wherein the auctioneer computing system comprises:
a brokerage criteria module adapted to accept brokerage criteria from potential brokerages via the full-time public network;
a purchaser criteria module adapted to accept purchaser criteria from potential brokerages via the full-time public network;
an auction module adapted to perform an auction-based transactional matching of accepted brokerage criteria to accepted purchaser criteria, wherein each criteria satisfies the requirements of the criteria to which it is matched;
a notification module adapted to notify, in response to the matching of an accepted brokerage criteria with an accepted purchaser criteria, the corresponding brokerage and the corresponding purchaser of the match via the full-time public network;
wherein the at least one brokerage computing system is adapted to communicably couple to the at least one purchaser computing system following conclusion of the auction-based match in order to execute post-auction activity in accordance with the terms of the brokerage criteria and the purchaser criteria.

16. The system of claim 15, wherein the auctioneer computing system further comprises:
a risk analytic module adapted to perform risk analytics on accepted brokerage criteria and accepted purchaser criteria in order to facilitate matching.

17. The system of claim 15, wherein the risk analytic module comprises computer-readable instructions, the execution of which perform the step of:
performing risk analytics on accepted brokerage criteria and accepted purchaser criteria in order to facilitate matching.

18. The system of claim 15, wherein the brokerage criteria module comprises computer-readable instructions, the execution of which perform the step of:
accepting brokerage criteria from potential brokerages via the full-time public network.

19. The system of claim 15, wherein the purchaser criteria module comprises computer-readable instructions, the execution of which perform the step of:
accepting purchaser criteria from potential brokerages via the full-time public network.

20. The system of claim 15, wherein the auction module comprises computer-readable instructions, the execution of which perform the step of:
performing an auction-based transactional matching of accepted brokerage criteria to accepted purchaser criteria, wherein each criteria satisfies the requirements of the criteria to which it is matched.

21. A method for auctioning stock stock transaction opportunities to brokerages using a full-time public network, including the steps of:
establishing a connection to a full-time public network;
accepting stock stock transaction criteria received from a purchaser via the full-time public network, including:
a stock transaction amount;
a stock transaction term;
a maximum specified interest rate;
accepting at least one bid from at least one brokerage via the full-time public network, the bid including a bid interest rate no more than the maximum specified interest rate;
selecting at least one winning bid from the accepted bids on the basis of its bid interest rate; and
notifying the purchaser of the winning bid, including the identity of the winning bidder and the winning bid interest rate.

22. The method of claim 21, further including the steps of:
notifying the winning brokerage of the purchaser's identity.

23. The method of claim 22, further including the step of:
facilitating the transfer of stock from the winning brokerage to the purchaser to fulfill the stock stock transaction opportunity according to the terms of the stock stock transaction criteria and the winning bid.
